(19) United States
(12) Patent Application Publication
(10) Pub. No.: US 2018/0183738 A1
(43) Pub. Date: Jun. 28, 2018

(54) ONLINE SOCIAL MEDIA INTERACTION SYSTEM

(71) Applicant: TEVIAN PARNELL, BIG SPRING, TX (US)

(72) Inventor: TEVIAN PARNELL, BIG SPRING, TX (US)

(21) Appl. No.: 15/389,161

(22) Filed: Dec. 22, 2016

(51) Int. Cl. H04L 12/58

(52) U.S. Cl. CPC H04L 51/046; H04L 51/36; H04L 67/42; H04L 51/20; H04L 51/32

(57) ABSTRACT

A system and method for connecting a number of users to enable interaction between the users through an integrated online social media and instant messaging platform is disclosed. The system includes an electronic communication device configured to run an integrated social media and instant messaging application, which includes a social networking module for providing a variety of social media related services to the users, a social media integration module for integrating a number of online social media platforms of the user and an instant messaging module for enabling interaction between the users. The system further includes a server in communication with the electronic communication devices to manage the contents presented through the integrated social media and instant messaging application over a communication channel. The integrated social media and instant messaging application allows the users to integrate online social media platforms, enable interaction between the users and publish the social media contents through a dynamic graphical user interface.

### BACKGROUND OF THE INVENTION

### Field of the Invention

The present invention generally relates to an online social networking system. More specifically, the present invention relates to a system and method for combining multiple online social media platforms and to provide a variety of social networking services to a user through an integrated online social media and instant messaging platform.

### Background of the Invention

A social networking service is an online platform that is used by people to build social networks or social relations with other people who share similar personal or career interests, activities, backgrounds or real-life connections. The online platform or application associated with each of the social networking services allow the users to register into the online platform or application to receive a variety of services offered by the platform. The users can register into the online platform or application associated with each of the social networking services by providing a variety of information including personal information of each user. The users can create their own social network profiles by providing personal information such as name, contact information, educational information, employment information, photographs, etc. In some social networking services, users can upload personal status messages, links to web related content of the user, blogs, etc. Other users of each of the social networking services can view some of the above said user information through the user interface of the online platform or application associated with the social networking services. The user information of a registered user, which is available to the public through the online platform or application associated with the social networking services, is utilized for building social networks or social relations with other people.

The social networking sites allow the registered users to identify and establish links or connections with other registered users in order to build or reflect social networks or social relations among the users. The users can select and establish links with other users of the social networking sites based on a number of factors such as location, user preferences, language, gender, professional interests etc. For instance, in the context of a business networking service, a person may establish a link or connection with his or her business contacts, including work colleagues, clients, customers, and so on. With a social networking service, a person may establish links or connections with his or her friends and family. A connection is generally formed using an invitation process in which one user “invites” a second user to form a link. The second user then has the option of accepting or declining the invitation. If the second user accepts the invitation, the first and second users are connected through the social networking site. When a first user forms a social networking connection with the second user through the social networking sites, the users can view each other's personal contents, which are otherwise not available in public. Moreover the users connected through the social networking sites can improve their social relation by communicating with each other through the social networking sites. In addition, the users connected through the social networking sites can view the contents published by them through the social networking sites or the contents of particular interests by the users, which are otherwise not available in public. This way the social networking sites build a personal relationship between the users and provide a platform for the users to interact with each other in the real world.

Currently social media includes an increasing number of platforms for users to connect and stay connected with others. Along with the increasing number of social media platforms, the various platforms are also increasing in complexity. Often, social media users access these various social media platforms with mobile devices, such as smartphones and/or tablets. However, due to the increasing number and complexity, navigating these social media platforms is becoming increasingly difficult, particularly for those who are not technologically savvy. Additionally, while many social networks are designed to keep users active, individuals are growing discontent with the amount of time required to maintain a presence on multiple platforms at one time. Hence there exists a need for a simple social media platform that integrates all the existing social media platforms of a user under a single service. Further the needed social media platform would allow the users to perform real-time communication either through a unique messaging method or through the existing social media platforms of the user already integrated to the social media platform.

There are certain prior arts such as U.S. Pat. No. 8,984,541 B1 titled “Social network application programming interface” issued to Zynga Inc. discloses a method for interfacing with multiple social networks. The method includes receiving a call from a social networking service agnostic social networking application for one of a plurality of social networking functions in a first format, translating the call in the first format to a call in a second format, the second format being one of a plurality of heterogeneous social networking service application programming interface formats, and passing the call in the second format to a first social networking service by utilizing a first social networking service application programming interface. However the above cited prior art doesn't offer a proper social networking platform and an all-in-one social networking application, that would allow the users to handle multiple social networking sites from a single application.

Another prior art US 20130091204 A1, titled “System and method of integrating various platforms and methods of using the same” filed by Joheem Loh, Randall Eike discloses systems and methods for integrating various platforms and streams, including social platforms and streams as well as networking, customer management, targeted marketing, and enterprise operations relating to the systems and methods. The present invention also includes methods of using the above integration, networking, publishing aggregation, and marketing and enterprise solutions. However the above cited prior art doesn't offer a proper social networking platform and an all-in-one social networking application, that would allow the users to handle multiple social networking sites using a single application.

Another application US 20160295009A1 titled “Application and method for integrating social media platforms” filed by Enrico Tones provides a method and system for social media interaction on a mobile computing device. The disclosed system for social media interaction on a mobile computing device includes a mobile computing device having an Internet connection to a remote server configured to host an application. An application installed on the mobile computing device includes a selection icon for selecting the application to activate the application for control of a variety of features of the mobile computing device. A secure login feature is provided when launching the application for registering a user and permitting access to a home screen associated with the application. The present system allows integration of multiple features and functions of a smartphone or other portable device through a single social media application that simplifies and streamlines use of the smartphone or device for social media users. However the above-disclosed application is not a platform for integrating multiple social networking sites and cannot be used to access the contents of each of those social networking sites. The above cited prior art doesn't offer a proper social networking platform and an all-in-one social networking application, that would allow the users to handle multiple social networking sites using a single application.

Hence, it can be seen that there is a need for a system and method for an online social networking platform that provides a variety of social networking capabilities to the user. The needed online social networking platform would allow the users to integrate multiple existing online social networking platforms and handle them through a user interface. The needed online social networking platform would allow the users to send messages to other users, directly using the platform or through the already integrated online social networking platforms. The needed system and method would further allow the users to send instant chats through the online social networking platform. The needed system and method would help the users to reduce the time spent for viewing and sharing contents through individual online social networking platform.

### SUMMARY

In view of the foregoing disadvantages inherent in the known types of systems like in the prior art, the present invention provides an improved system and method for connecting a number of users and to enable interaction between the users through an integrated online social media and instant messaging platform. The present system includes an electronic communication device configured to run an integrated social media and instant messaging application. The integrated social media and instant messaging application provides a platform for the users to integrate their online social media platforms. The integrated social media and instant messaging application also functions as a new online social media application, which provides several unique social networking features compared to the existing online social media platforms. The integrated social media and instant messaging application installed on the electronic communication device includes several modules such as, but not limited to, a social networking module for providing a variety of social media related services to the users, a social media integration module for integrating existing online social media platforms of the users and an instant messaging module for enabling interaction between the users through the integrated social media and instant messaging application. The present system further includes a server in communication with the electronic communication devices running the integrated social media and instant messaging application to manage a variety of contents presented through the integrated social media and instant messaging application. The electronic communication devices running the integrated social media and instant messaging application, transfers the contents between devices through the server over a communication channel, which enable secure communication between the electronic communication devices of the users and the server. The integrated social media and instant messaging application running on the electronic communication devices allows the users to integrate his/her online social media platforms, enable interaction between the users and allows the users to publish desired contents through a dynamic user interface of the integrated social media and instant messaging application.

Accordingly, it is an object of the present invention to provide an integrated online social media and instant messaging platform to enable interaction between the users.

Yet another objective of the present invention provides an integrated online social media and instant messaging platform to integrate multiple online social media platforms of the user.

It is another objective of the present invention is to provide a unique social networking service to the users of the integrated online social media and instant messaging platform.

Yet another objective of the present invention is to provide a messaging platform, which would allow the user to send and receive messages through the integrated online social media and instant messaging platform.

Another objective of the present invention is to provide a chat platform, which would allow the user to send and receive instant chats through the integrated online social media and instant messaging platform.

Another objective of the present invention is to allow the users to send and receive short-lived messages through the integrated online social media and instant messaging platform.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness. The invention will be described and explained with additional specificity and detail through the use of the accompanying drawing in which:

FIG. 1 illustrates a block diagram showing the present system for connecting users and to enable interaction between the users through an integrated online social media and instant messaging platform, according to a preferred embodiment of the present disclosure;

FIG. 2 is a block diagram showing the different components and modules of the electronic communication device running the integrated social media and instant messaging application, according to a preferred embodiment of the present invention;

FIG. 3 is a block diagram showing the different components and modules of the server in communication with the electronic communication device running the integrated social media and instant messaging application, according to a preferred embodiment of the present invention;

FIG. 4A represents a welcome page of the integrated social media and instant messaging application launched on the electronic communication device, according to an embodiment of the present disclosure;

FIG. 4B represents the registration or sign up page of the integrated social media and instant messaging application, according to an embodiment of the present disclosure;

FIG. 4C represents the online social media platform integration page of the integrated social media and instant messaging application, according to an embodiment of the present disclosure;

FIG. 4D shows the contents of the online social media platforms linked to the integrated social media and instant messaging application, according to an embodiment of the present disclosure;

FIG. 5 is a flowchart showing the steps of the present method for connecting a number of users and enable interaction between the users through an integrated online social media and instant messaging platform, according to a preferred embodiment of the present invention; and

FIG. 6A to FIG. 6F shows the method of launching the replicated user interfaces for the online social media platforms from within the dynamic user interface of the integrated social media and instant messaging application using gestures, according to an embodiment of the present invention.

### DETAILED DESCRIPTION OF THE INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention. The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. The following embodiments and the accompanying drawings, which are incorporated into and form part of this disclosure, illustrate one or more embodiment of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

This section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations

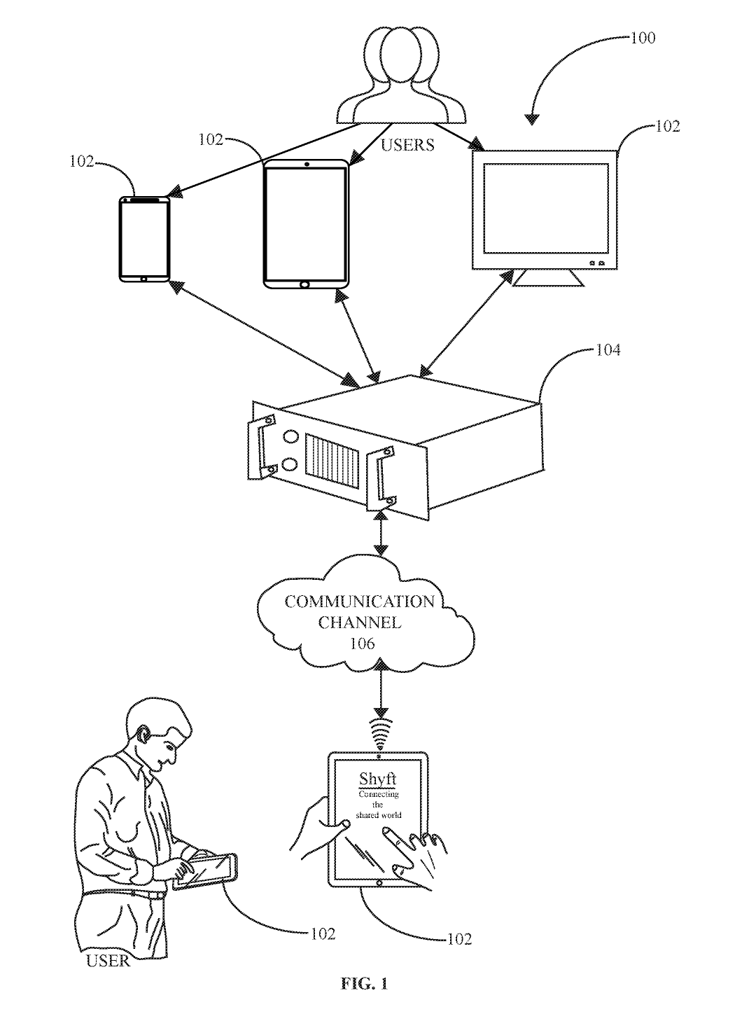

The present disclosure relates to a system and method for connecting a number of users through an integrated online social media and instant messaging platform. The present system and method further enables interaction between the users through the integrated online social media and instant messaging platform. The present integrated online social media and instant messaging platform provides a variety of features such as, but not limited to, social media related services, integration and direct communication with other online social media platforms and instant messaging services to the users. The proposed integrated online social media and instant messaging platform can be used as an all-in-one social media application or social networking service that provides a variety of unique features and all the features of the existing social media applications by integrating the existing social media applications into the platform. FIG. 1 illustrates a block diagram showing the present system 100 for connecting the users and to enable interaction between the users through an integrated online social media and instant messaging platform. The present system 100 includes an electronic communication device 102 configured to run an integrated social media and instant messaging application. The integrated social media and instant messaging application provides a platform for the users to integrate their online social media platforms and also offers a new online social media application or social networking service, which includes several unique features compared to the existing online social media platforms. The integrated social media and instant messaging application installed on the electronic communication device 102 includes several modules such as, but not limited to, a social networking module for providing a variety of social media related services to the users, a social media integration module for integrating existing online social media platforms of the users and an instant messaging module for enabling interaction between the users through the integrated social media and instant messaging application. The present system 100 further includes a server 104 in communication with the electronic communication devices 102 running the integrated social media and instant messaging application to manage a variety of contents presented through the integrated social media and instant messaging application. The electronic communication devices 102 running the integrated social media and instant messaging application, transfers the contents between devices 102 through the server 104 over a communication channel 106, which enable secure communication between the electronic communication devices 102 of the users and the server 104. The integrated social media and instant messaging application running on the electronic communication devices 102 allows the users to integrate his/her online social media platforms, enable interaction between the users and allows the users to publish desired contents through a dynamic user interface of the integrated social media and instant messaging application.

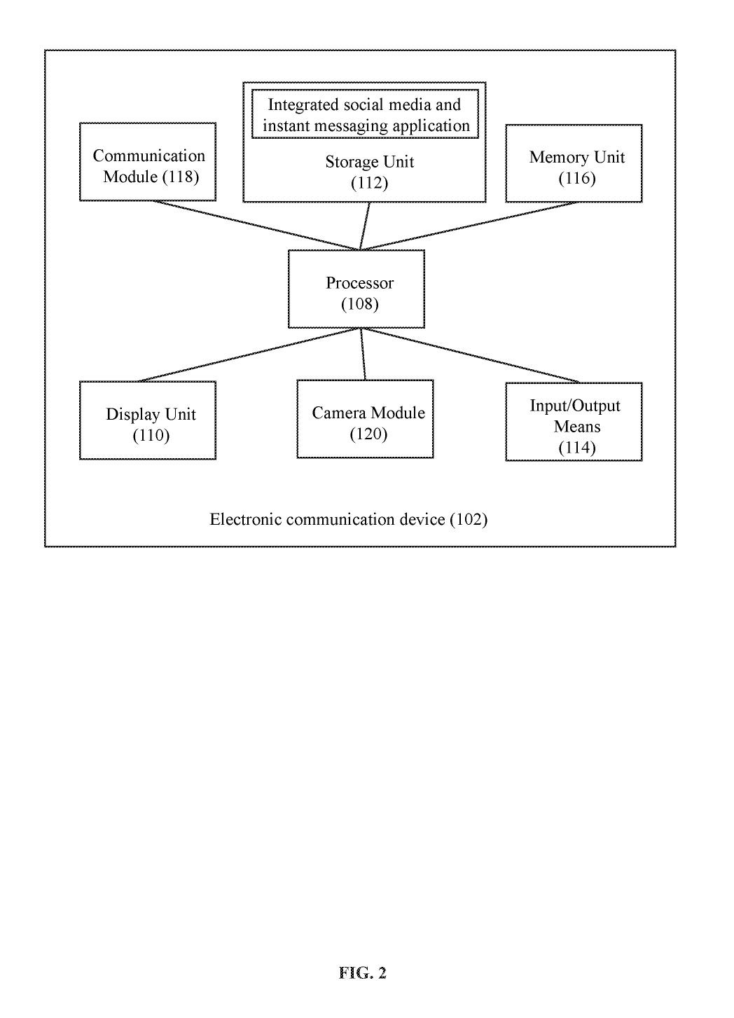

The hardware and software components of the present system 100 are discussed in detail below prior to disclosing the unique features and services offered by one or more embodiment of the present system 100. FIG. 2 is a block diagram showing the different components and modules of the electronic communication device 102 running the integrated social media and instant messaging application, according to a preferred embodiment of the present invention. The electronic communication device 102 can be smart devices such as, but not limited to, a smartphone, tablet, computer, smart wearable devices, and other smart devices connected to the Internet and capable of displaying a dynamic graphical user interface (GUI) of the integrated social media and instant messaging application. The electronic communication device 102 includes a processor 108 to process a number of instructions of the integrated social media and instant messaging application, a display unit 110 for displaying the dynamic graphical user interface of the integrated social media and instant messaging application, a storage unit 112 for storing a variety of data including contents shared or received through the integrated social media and instant messaging application, an input/output means 114 for allowing the users to interact with the dynamic graphical user interface of the integrated social media and instant messaging application, a memory unit 116 for temporarily storing the data and instructions while performing a number of operations by the processor 108 based on the instructions of the integrated social media and instant messaging application and a communication module 118 to enable communication between the electronic communication devices 102 and the server 104 via the communication channel 106. The users are allowed to interact with the contents of the integrated social media and instant messaging application through the dynamic graphical user interface using the input/output means 114. The users are allowed to interact with the contents presented on the dynamic graphical user interface of the integrated social media and instant messaging application using a keyboard, pointing device such as a mouse, at least one gesture or touch, voice activation, or any other interacting means. The electronic communication devices 102 further includes a camera module 120 to capture the contents including images and videos and share the captured contents through the dynamic graphical user interface of the integrated social media and instant messaging application. Further, the input/output means 114 allows the users to respond or react to the contents presented through the dynamic graphical user interface of the integrated social media and instant messaging application using text, voice i.e. as audio response or audio comments, pictures, videos or special characters such as, but not limited to, emojis and other symbols. Further the input/output means 114 allows the users to view or listen to the reactions or responses from other users on the contents presented through the dynamic graphical user interface of the integrated social media and instant messaging application.

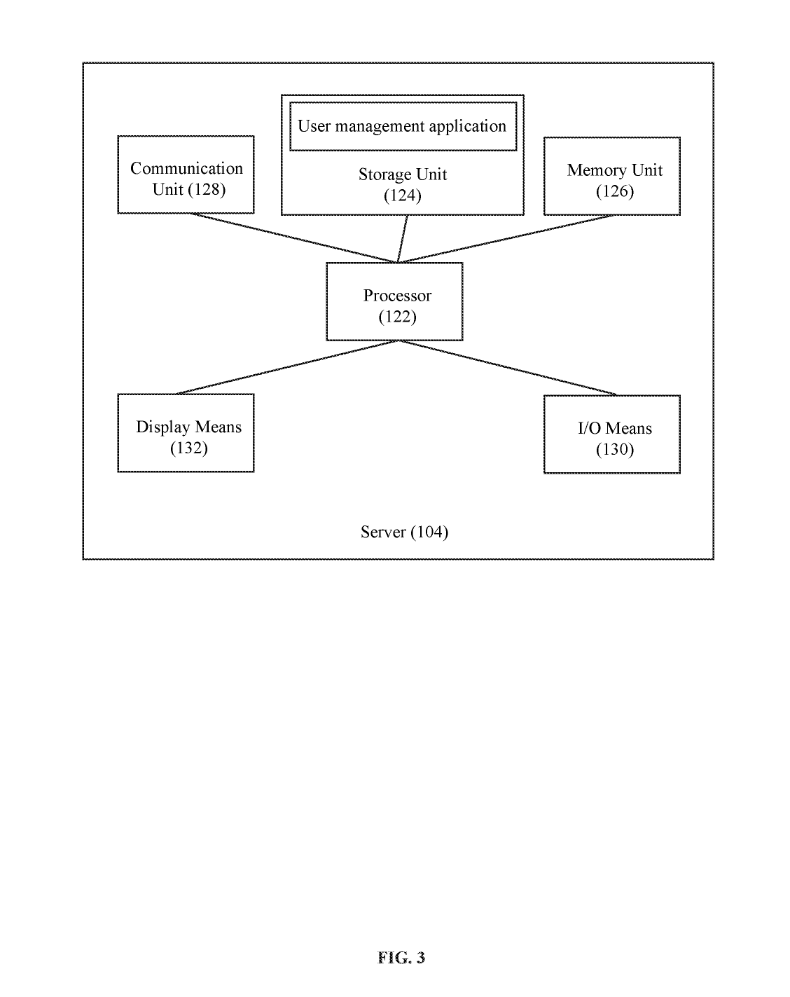

According to a preferred embodiment of the present system 100, all the communication between the integrated social media and instant messaging application running on the electronic devices of the users are performed through the server 104 over the communication channel 106. The server 104 can be a physical server 104 located at one or more locations or a central cloud server 104 offering services to the users via the integrated social media and instant messaging application connected to the central cloud server 104. FIG. 3 is a block diagram showing the different components and modules of the server 104 in communication with the electronic communication device 102 running the integrated social media and instant messaging application, according to a preferred embodiment of the present invention. The server 104 includes similar components as any normal server or a computer, which includes a processor 122, a storage unit 124, a memory unit 126, a communication unit 128, an input/output (I/O) means 130 and a display means 132. The server 104 is in communication with the electronic communication devices 102 in real-time over the Internet enabled by the communication unit 128. In some instances, the server 104 is installed with a user management application configured to manage the operations of the integrated social media and instant messaging application running on the electronic communication devices 102. The user management application is stored in the storage unit 124 and the processor 122, when required, executes the instructions of the user management application. The memory unit 126 stores the data associated with the user management application when the processor 122 executes the instructions of the application. The user management application includes a user management module that handles all the information related to the user registration and all other user related activities performed by the users through the integrated social media and instant messaging application running on their electronic communication devices 102. The user management application running on the server 104 further includes a content management module that receives and temporarily or permanently stores the contents to be presented through the dynamic graphical user interface of the integrated social media and instant messaging application running on the electronic communication devices 102. The content management module manages the contents and the responses or reactions on each of the contents by the users provided through the integrated social media and instant messaging application running on the electronic communication devices 102. In some instances, the user management application running on the server 104 is in communication with a chat server, which manages the real-time chats between the users through the integrated social media and instant messaging application. In some other instance, the chat server and the server 104 are the same device, offering social media and instant chat services to the users.

The users can download the integrated social media and instant messaging application from Internet sources including, but not limited to, iTunes store or App store, Google play store and many other software stores and install the application in their electronic communication devices 102 such as Smartphones. In some instance, different versions of the integrated social media and instant messaging application are available from the Internet sources, each version is configured to optimally run on different electronic communication devices 102 such as tablet, smartphone, smart wearable device etc., and the users can select and download the desired versions of the integrated social media and instant messaging application into their electronic communication device 102. After downloading and installing the integrated social media and instant messaging application, the users can launch the application from the electronic communication device 102 and view the dynamic graphical user interface, which allows the users to perform a number of tasks such as, but not limited to, user registration, online social media platforms integration, instant chats, etc.

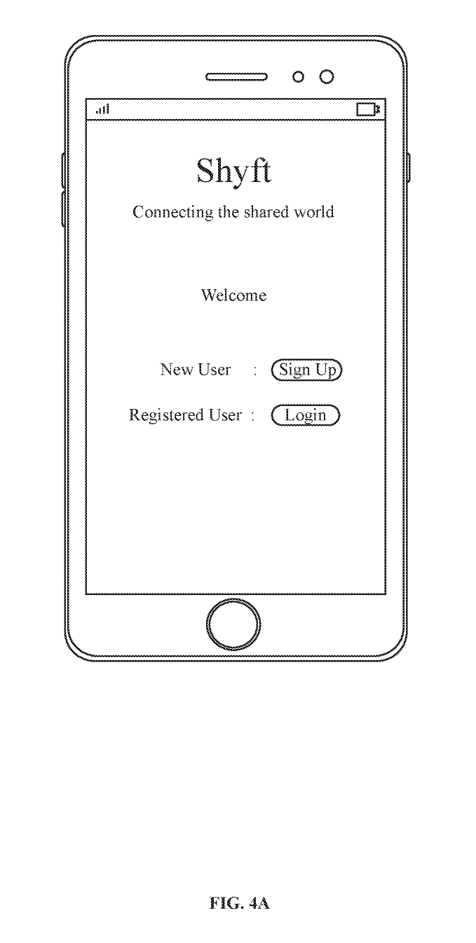

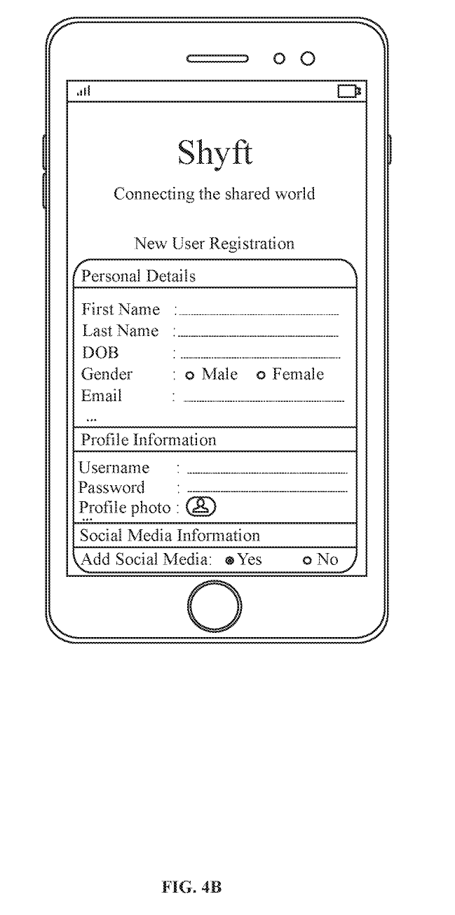

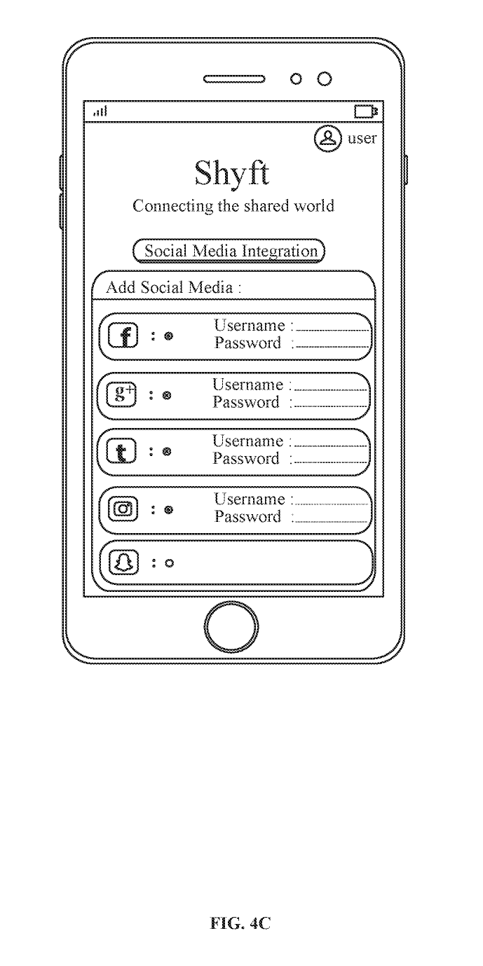

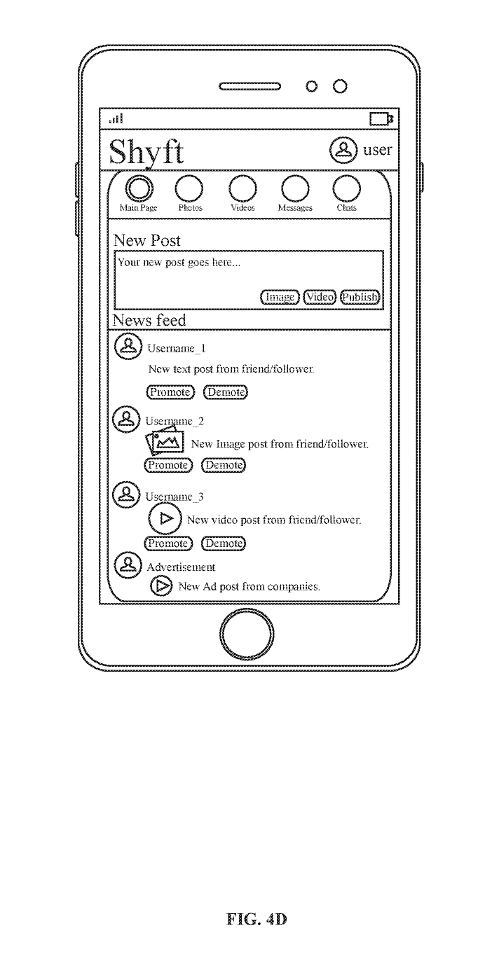

FIG. 4A to FIG. 4D represents the illustrative dynamic graphical user interfaces of the electronic communication device 102, according to one or more embodiment of the present disclosure. However, the design of the dynamic graphical user interface of the present integrated social media and instant messaging application may differ from the sample illustrations shown in FIG. 4A to FIG. 4D. FIG. 4A represents a welcome page of the integrated social media and instant messaging application launched on the electronic communication device 102, according to an embodiment of the present disclosure. The welcome page of the integrated social media and instant messaging application prompts the new users to register into the application and prompts the existing users to log into the application using unique credentials provided to the existing users. FIG. 4B represents the registration or sign up page of the integrated social media and instant messaging application, according to an embodiment of the present disclosure. The registration or sign up page of the integrated social media and instant messaging application prompts the users to enter their personal details, such as, name, age, contact information, preferences, etc. and also allows the user to upload one or more profile pictures. Once the user completes the registration, he/she will be provided a unique username and password or allowed to select a desired username and password for logging into the integrated social media and instant messaging application.

After completing the user registration process, as shown in FIG. 4B, the integrated social media and instant messaging application directs the users to an online social media platforms integration page, as is shown in FIG. 4C. From the online social media platforms integration page, the users are allowed to select or add the online social media platforms including, but not limited to, Facebook, twitter, Google plus, Instagram, Snapchat, YouTube and other online content sharing, social networking and instant messaging applications where the users having existing accounts. The users can select the desired online social media platforms and enter the user credentials for each of the online social media platforms through the graphical user interface of the present integrated social media and instant messaging application. After linking the desired online social media platforms, the user can view contents of him/her published through the online social media platforms, the contents published by other users, whom the user follows or subscribed to, and the contents publicly shared by other users as shown in FIG. 4D. For example, the users of the present integrated social media and instant messaging application can view the contents of the integrated online social media platforms, such as, but not limited to, new updates or new posts or comments published through twitter, or any Facebook content published by the user or by Facebook friends or followers of the user, YouTube videos published by the user or videos from channels subscribed the user, etc. In addition, the users of the present integrated social media and instant messaging application can list the usernames of each of the online social media platforms in the profile page of the user, which can be viewed by other users, through the profile page of the user displayed in the integrated social media and instant messaging application. Moreover, the users can connect to the online social media platforms of other users by ‘clicking’ or selecting the usernames displayed on the profile page of the user displayed in the integrated social media and instant messaging application. For example, a first user can list his/her online social media platform usernames such as Facebook username, twitter username, Snapchat username, etc. on the profile page of the integrated social media and instant messaging application. Other users clicking on the Facebook or twitter or Snapchat username listed on the profile page of the first user receives a pop up window asking them, whether they want to add the first user and if he/she selects “yes”, then a friend request or follow or subscribe request for the particular online social media platform from the other user's account is sent to the first user. The first user can receive the friend request or follow or subscribe request through the integrated social media and instant messaging application and can either accept or reject the request.

The present integrated social media and instant messaging application includes the social networking module that provides a variety of social media related services to the users. The social media related services or features provided by the present integrated social media and instant messaging application includes, but not limited to, publishing or sharing of contents such as text, audio, image or video through the dynamic graphical user interface of the integrated social media and instant messaging application, updating or publishing special events, sending/receiving friend or follow/subscribe requests, etc. Further the integrated social media and instant messaging application includes a status feed, which displays all the updates from other online social media platforms integrated to the present application. The dynamic graphical user interface of the integrated social media and instant messaging application mirrors or replicates the status feed of other online social media platforms and allows the users to manage all the notifications and updates from other online social media platforms integrated to the present application. The integrated social media and instant messaging application allows the users to publish contents through the dynamic graphical user interface and allows other users to react or respond to those contents. The dynamic graphical user interface of the integrated social media and instant messaging application includes features such as promote or demote options that allow other users to either promote or demote the contents published through the present application. The position of the contents published by a user through the dynamic graphical user interface is dynamically or automatically updated based on the responses received from the other users. For example, when a first user publishes or shares a content or status such as a video or any other content through the dynamic graphical user interface of the integrated social media and instant messaging application, other users following the first user can view and promote/demote the content published by the first user. As a published content or the news or the status message receives more and more promotes from the followers, the content published by the first user stays on the top portion of the dynamic graphical user interface and as the number of promotes reduces, the content published by the first user drops to the bottom of the dynamic graphical user interface and at the same time the top position on the dynamic graphical user interface gets occupied by other contents with highest promotes. Further the media contents such as photo or video published by the users through the integrated social media and instant messaging application may have a like or dislike button associated with it, similar to the Facebook like button or YouTube like/dislike buttons, so that other users can like or dislike the media contents published through the dynamic graphical user interface of the present application.

The integrated social media and instant messaging application allows the users to advertise through the dynamic graphical user interface and to send invitations to other users to join the application and to view the contents presented through the dynamic graphical user interface of the application. The present integrated social media and instant messaging application allows different types of features for different types of users. For example, from the main page of the integrated social media and instant messaging application, the user can select the account to be a normal user account for personal use, or an account of entrepreneurs or companies who wants to advertise their products such as shoe brands, apparel brands etc. or services such as holiday trip booking services, online shopping services etc. or accounts for bloggers who is part of a group such as book club, etc. Each type of user can publish and promote their contents through the dynamic graphical user interface of the integrated social media and instant messaging application. Moreover, the integrated social media and instant messaging application allows the users to publish the same contents through other online social media platforms such as, but not limited to, Facebook, YouTube, twitter, etc., from within the dynamic graphical user interface of the integrated social media and instant messaging application. Hence the present system 100 allows the users to publish or share desired contents through multiple online social media platforms from within the dynamic graphical user interface of the present integrated social media and instant messaging application. This saves time and is convenient for the users who would like to publish the contents through multiple online social media platforms. In some embodiment, the integrated social media and instant messaging application allows the users to store the media contents, such as, audio, video and image, to the electronic communication device 102. This allows the users to save or store the published or received media through the online social media platforms integrated to the present integrated social media and instant messaging application in the storage unit 112 of the electronic communication device 102. Further the users can directly publish the media contents, such as, audio, video and image, stored in the storage unit 112 of the electronic communication device 102 through the dynamic user interface of the present integrated social media and instant messaging application or through the selected online social media platforms integrated to the present integrated social media and instant messaging application. In a yet another embodiment, integrated social media and instant messaging application allows the users to store the media contents published or received media through the online social media platforms integrated to the present application in one or more cloud storage platforms such as, but not limited to, Google drive, Dropbox etc.

According to one or more embodiment of the present system 100, the integrated social media and instant messaging application running on the electronic communication devices 102 allow the users to perform a variety of tasks including integrating and interacting with the online social media platforms through the dynamic graphical user interface of the integrated social media and instant messaging application, capture a variety of contents including image and video using the camera module 120 of the electronic communication device 102 and edit the contents using editing tools provided through the dynamic graphical user interface of the integrated social media and instant messaging application. After properly editing the contents, including the captured image and video, the users are allowed to publish the contents through the selected online social media platforms and through the dynamic graphical user interface of the integrated social media and instant messaging application. The users can launch the camera module 120 of the electronic communication devices 102 from within the dynamic graphical user interface of the integrated social media and instant messaging application and capture an image or a video and can be edited in real-time using the editing tools, such as, but not limited to, crop, enhance, color, rotate, etc., presented to the user through the dynamic graphical user interface of the application. The users can send the edited images or the videos to other users as private messages or post or publish or share through the integrated online social media platforms, such as, but not limited to Facebook, Instagram, YouTube, etc. As soon as the user captures a picture by launching the camera module 120 from within the dynamic graphical user interface of the integrated social media and instant messaging application, the pop-up message appears on the dynamic graphical user interface asking the user whether he wants to post the image or video through the integrated online social media platforms or through the dynamic graphical user interface of the application or to save the image or video into the electronic communication device 102. The users can later publish or share the captured image or video through the dynamic graphical user interface of the integrated social media and instant messaging application.

In addition, the present integrated social media and instant messaging application allows the users to record their voice and send the voice content to one or more selected users. In some instance, the present integrated social media and instant messaging application can be used for real-time voice communication between the users, similar to the functionality offered by a walky-talky device. In some other embodiment, the users can edit the voice in real-time, so that he/she can use the voice of other preset person's voice with different tone or dialect, such as, Larry the cable guy's voice or other celebrity voice and can send the voice message to other users. In some other instance, the integrated social media and instant messaging application includes a voice to text translation engine to allow the users to record audio or their own voice and translate it into text before sending it to other users through the application. In some other instance, the users can record voice and translate the voice into text using the present integrated social media and instant messaging application and can publish the text through the dynamic graphical user interface of the application. Further the users are also allowed to enter text information or text content through the input/output means 114, such as a keyboard or touch sensitive screen of the electronic communication device 102, and send the text to other users or publish the text through the dynamic graphical user interface of the application. The dynamic graphical user interface of the integrated social media and instant messaging includes text modification or text-editing tools to format the text as desired by the users.

The present integrated social media and instant messaging application allows the users to send the contents such as text, audio, image and video as short-lived messages to other users. The contents of the short-lived messages are permanently deleted once the message has been opened and read by the receiver. In some other instance, the sender of the contents can set a time frame for which the receiver can view the contents of the message and the contents gets permanently deleted from the electronic communication device 102 of the receiver and the server 104 after the time frame set by the sender. In case, if the receiver forgets or ignores to open the message, the contents of the messages are not deleted. In some instance, the present integrated social media and instant messaging application allows the users to set a time frame for the short-lived messages up to three minutes from the time the receiver opens or view the contents of the message and after which the contents of the message are permanently deleted automatically. In some other instance, the integrated social media and instant messaging application allows the users to send emojis or emoticons. In some instances, the integrated social media and instant messaging application allows the users to send special characters or designs or custom emojis such as, but not limited to, emojis with Justin beiber's hair style or people with skinny jeans, etc. In some cases, the integrated social media and instant messaging application allows the users to create or draw special emojis through the dynamic graphical user interface displayed on the touch screen display unit 110 of the electronic communication device such as a smartphone.

The integrated social media and instant messaging application further allows the users to launch the camera module 120 from within the dynamic graphical user interface and record videos of any desired length. The integrated social media and instant messaging application includes options to save the recorded videos in the storage unit 112 of the electronic communication device 102 or in the server 104 or on one or more cloud storage platforms such as, but not limited to, Google drive, Dropbox etc. Further the integrated social media and instant messaging application also enables the users to publish the videos through the dynamic graphical user interface of the application, share with other users in the friend list, or post in selected online social media platforms such as YouTube. When the user launches the integrated social media and instant messaging application and captures a video using the electronic communication device 102, a pop-up window appears on the dynamic graphical user interface of the application asking whether the user want to save this video, send this video to someone or multiple persons present in the friend list of the user, publish in the profile of the user or publish through the selected online social media platforms. The integrated social media and instant messaging application enables the users to perform real-time editing of the video, such as forming a slow motion videos, changing the quality of the video etc. For example, the integrated social media and instant messaging application allow the users to change the background of the video to a desired geographical location and share or save the video. In some instance, the integrated social media and instant messaging application includes a search button that allow the users to scan for a desired content stored in the storage unit 112 of the electronic communication device 102 or in the storage unit 124 of the server 104.

The integrated social media and instant messaging application allows the users to perform real-time chats through a chat window launched on the dynamic graphical user interface of the application. The users can share text, audio, image and video through the chat window and the contents shared are permanently deleted once the receiver views or reads the content of the chat. The integrated social media and instant messaging application includes a unique feature that allow the users to perform review of a picture or a video received from every person he/she is friends for a time frame if the picture or video is send it to the user privately. The dynamic graphical user interface of the application includes a review button that allows the users to review multiple images and videos sent by other users in a single window. For example, if someone sends five images to a person, he/she can review the five pictures together instead of seeing one by one. The images are deleted once the user the receiver views the image or after a preset time frame by the sender. Further the integrated social media and instant messaging application allows the users to use other people's voice or distorted voice during voice or video chatting through the chat window. Further the integrated social media and instant messaging application allows the users to take pictures and perform real-time video chats with the actual geographic background or other places such as, but not limited to, Disney world or Las Vegas casino as the background. In addition, the integrated social media and instant messaging application includes real-time video editing features such as the ability to capture slow motion or fast rate videos from the dynamic graphical user interface of the application. Further the integrated social media and instant messaging application includes options to edit the captured videos and images to look like it's raining, snowing, windy, sunny etc., irrespective or the actual weather condition. For example, a user can launch the integrated social media and instant messaging application to capture a picture and can edit the picture to put the user with special backgrounds or with any animal they choose.

The integrated social media and instant messaging application includes a livetime feature to allow the users to stream live images and video during real-time chats. The images and video shared using the livetime feature are made available to other users in form of public content through the dynamic graphical user interface of the application. If the content is not shared during livetime then nobody can see the content except those users to whom the first user sends the content. Further the integrated social media and instant messaging application allows the users to follow and/or subscribe to other users to receive the contents published by the other users through the dynamic user interface, where the contents published by the other users are presented through the dynamic user interface in form of a story mode. In story mode presentation of the contents, only the people whom the user follow and/or the people who follow the user can see the contents such as the captured video or picture. The integrated social media and instant messaging application also allow the users to edit the captured video or picture by inserting text content over the video or the picture and can publish the content through the dynamic graphical user interface or through other integrated online social media platforms or can be saved to the electronic communication device 102. The dynamic graphical user interface of the integrated social media and instant messaging application presents a ‘what's up feed’ feature to the users to publish real-time events and incidents or news happening around the users. The users can publish the real-time events in form of text, audio, image and video through the dynamic graphical user interface.

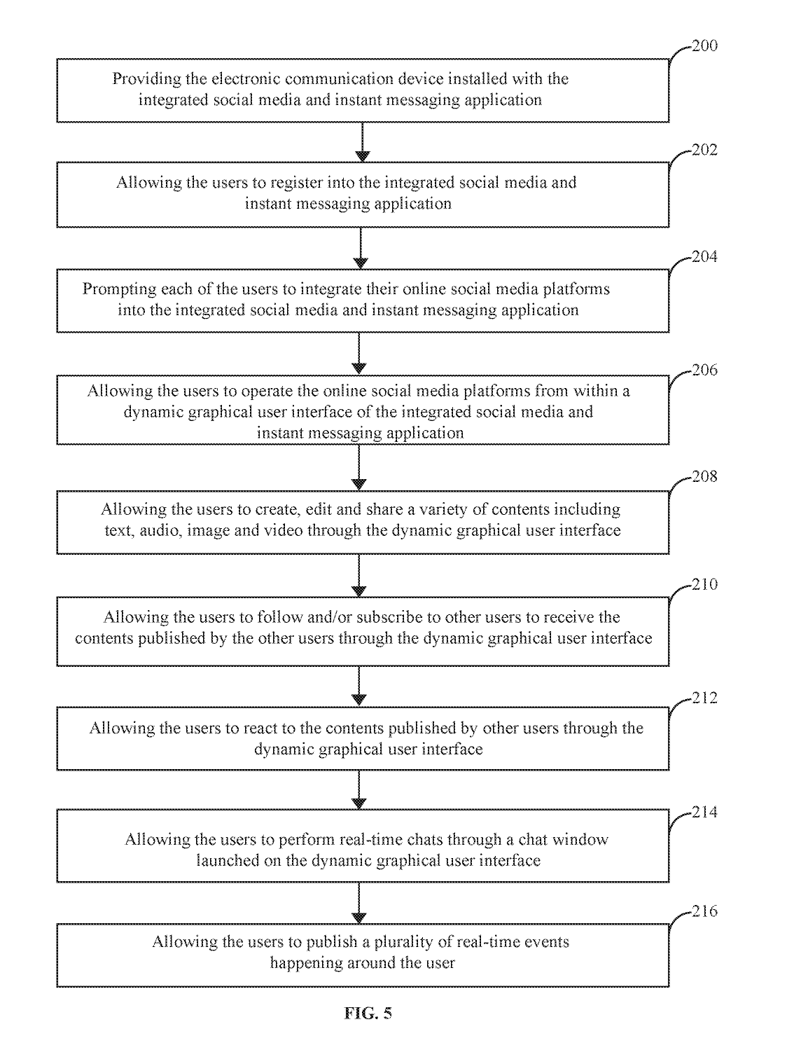

FIG. 5 is a flowchart showing the steps of the present method for connecting a number of users and enable interaction between the users through an integrated online social media and instant messaging platform, according to a preferred embodiment of the present invention. The method starts with the step of providing the electronic communication device 102 installed with the integrated social media and instant messaging application to the users as shown in block 200. Further the users are allowed to register into the integrated social media and instant messaging application as in block 202 and after successful registration, each of the users are prompted to integrate a his/her online social media platforms into the integrated social media and instant messaging application as shown in block 204. The present integrated social media and instant messaging application allows the users to operate the online social media platforms from within a dynamic graphical user interface of the integrated social media and instant messaging application as stated in block 206. Further, as in block 208, the users are allowed to create, edit and share a variety of contents including text, audio, image and video through the dynamic user interface. The users are also allowed to follow and/or subscribe to other users to receive the contents published by the other users as stated in block 210. The integrated social media and instant messaging application also allows the users to react to the contents published by other users through the dynamic user interface, as shown in block 212. As stated in block 214, the users are allowed to perform real-time chats through a chat window launched on the dynamic user interface of the integrated social media and instant messaging application and the users can send short-lived messages to other users during the real-time chat. The users are also allowed to perform public live streaming of images and videos through the dynamic user interface during a livetime feature associated with the real-time chats. Further the users can publish information related to the real-time events occurring around the user as in block 216. The users can publish the information related to the real-time events in form of text, audio, image and video through the dynamic user interface of the integrated social media and instant messaging application.

The users are allowed to share contents through a story mode presentation through the dynamic user interface and through the online social media platforms integrated into the integrated social media and instant messaging application. The dynamic user interface of the integrated social media and instant messaging application presents replicated user interfaces for the online social media platforms such as, but not limited to, Facebook, twitter, Google plus, Instagram, Snapchat, YouTube and other online content sharing, social networking and instant messaging applications. The users can launch the replicated user interfaces for the online social media platforms from within the dynamic user interface of the integrated social media and instant messaging application using a variety of gestures.

In some instances, the display unit 110 of the electronic communication device 102 running the present integrated social media and instant messaging application is a touch screen display that allows the users to interact with the dynamic graphical user interface using touch or gestures. According to an embodiment of the present invention, the integrated social media and instant messaging application configured to run on the electronic communication device 102 includes five pages to be displayed through the dynamic graphical user interface, including a main page, messaging page, images page, videos page and a chat window page. Gestures on each page displayed through the dynamic graphical user interface results in same or different actions. For example, tapping twice and holding the finger on the touch screen display on the second tap for two second cause the page of the application, whether it be the main page, messaging, photos, chats or video page, to zoom out allowing the user to view all the pages on the application similar to the action of pressing the home button on an iPhone and it zooms out and shows every open window. After listing all the pages, the user can then either swipe left or right and the pages rotates clockwise for swiping left and counter clockwise for swiping right. The user can then select the main page or video, photo, chats, or messaging page by taping the screen and that page zooms in to form the full page on the dynamic graphical user interface on the touch screen display.

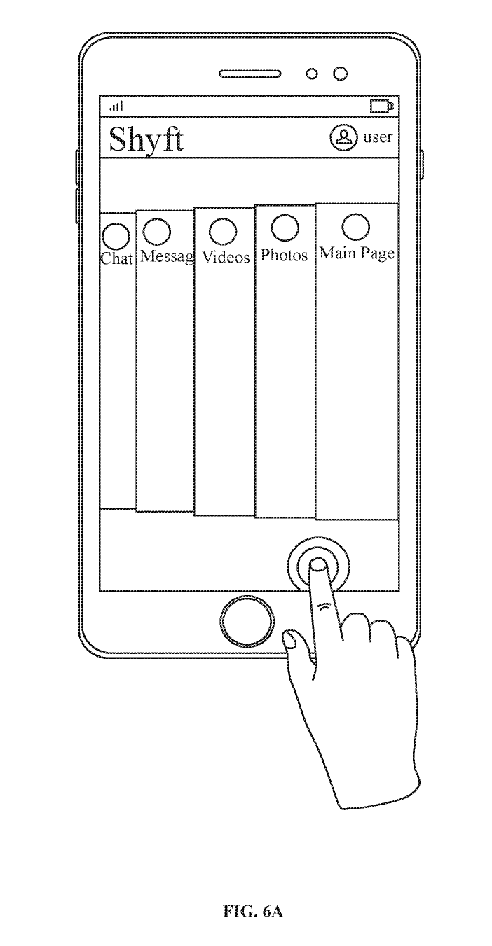

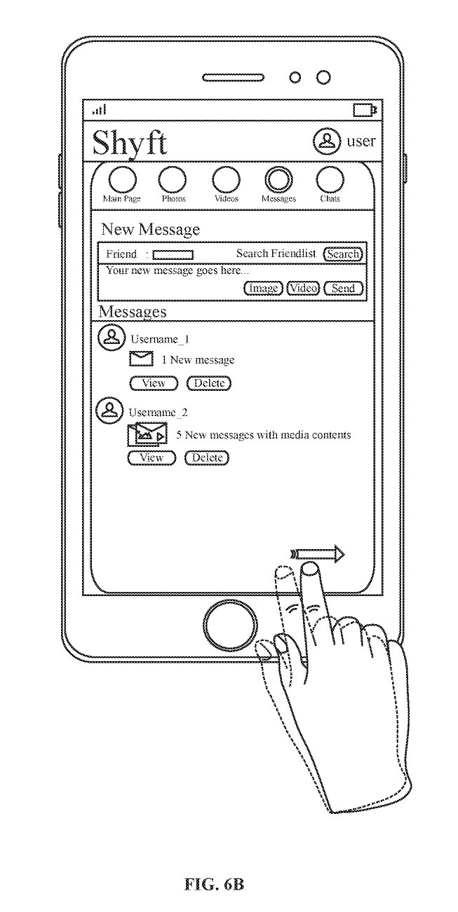

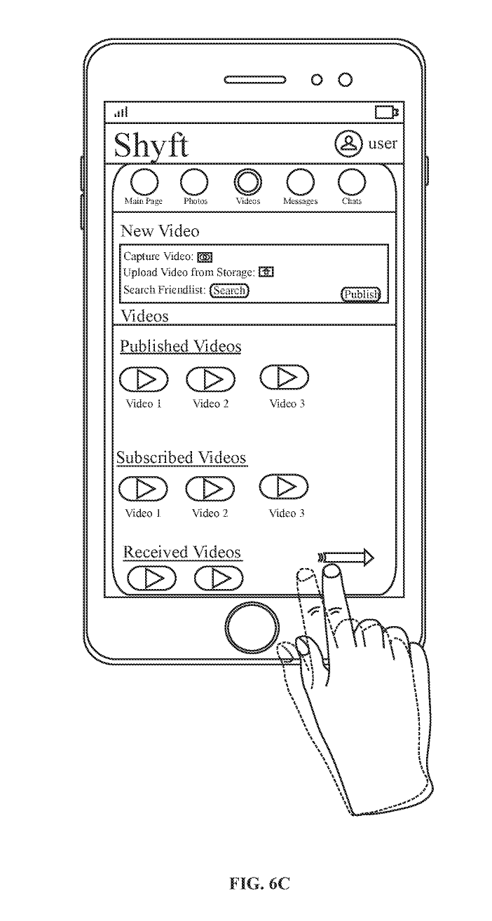

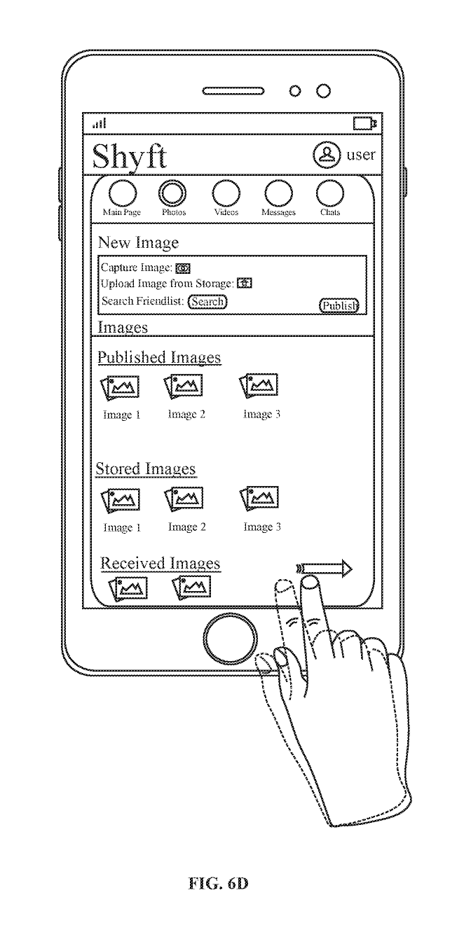

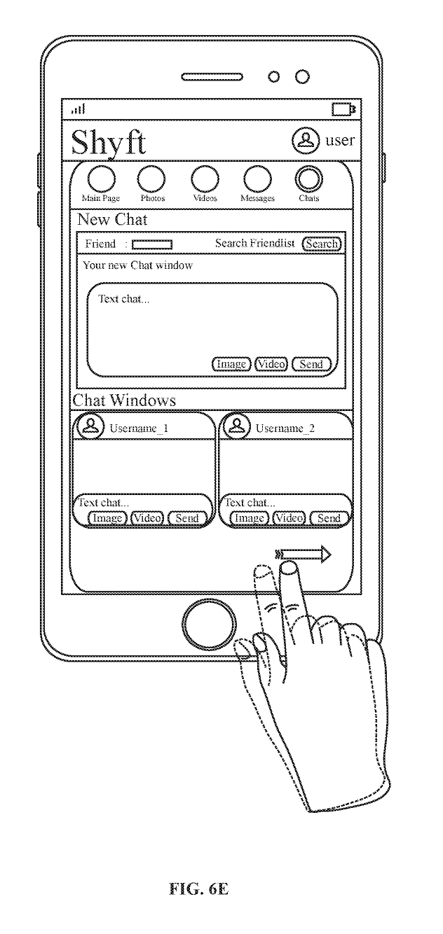

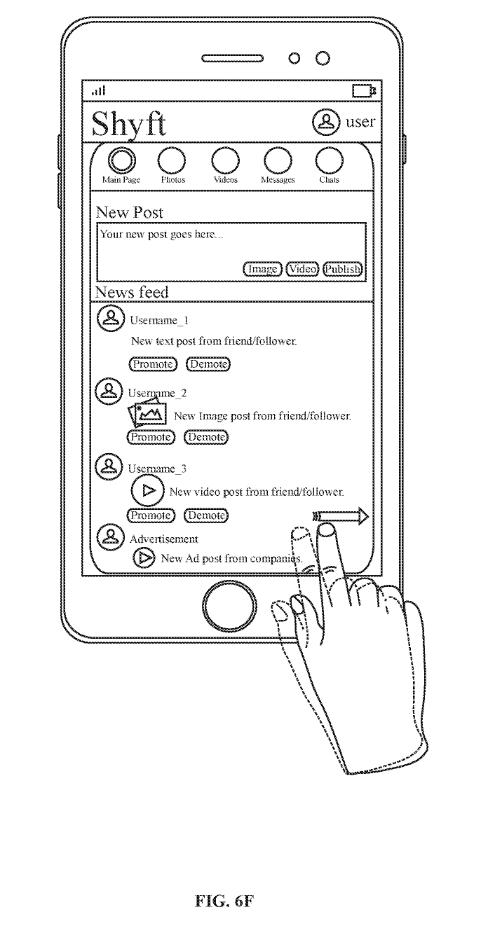

FIG. 6A to FIG. 6F shows the method of launching the replicated user interfaces for the online social media platforms from within the dynamic user interface of the integrated social media and instant messaging application using gestures, according to an embodiment of the present invention. For example, if a user wants to access the main page that includes his/her profile and all the status feeds, he/she can just tap twice on the touch screen display and holding the second tap for two seconds zooms out to show all the page from where the user can swipe left or right and tap to select the main page of the application, as shown in FIG. 6A. FIG. 6B shows the method of launching the replicated user interface of Facebook application from within the dynamic user interface of the integrated social media and instant messaging application using gestures. If the Facebook account of the user is linked to the present application, then the user can launch the replicated user interface of Facebook by going to the messaging page as described in FIG. 6A and swipe left to view the replicated user interface of the Facebook account of the user. The replicated user interface of Facebook account of the user is displayed as if the user is looking at the Facebook app. FIG. 6C shows the method of launching the replicated user interface of YouTube application from within the dynamic user interface of the integrated social media and instant messaging application using gestures. If the YouTube account of the user is linked to the present application, then the user can launch the replicated user interface of YouTube by going to the videos page as described in FIG. 6A and swipe left to view the replicated user interface of the YouTube account of the user. FIG. 6D shows the method of launching the replicated user interface of Instagram application from within the dynamic user interface of the integrated social media and instant messaging application using gestures. If the Instagram account of the user is linked to the present application then the user can launch the replicated user interface of Instagram by going to the photos page as described in FIG. 6A and swipe left to view the replicated user interface of the Instagram account of the user. Similarly, FIG. 6E shows the method of launching the replicated user interface of Snapchat application from within the dynamic user interface of the integrated social media and instant messaging application using gestures. First the user is directed to the chat page through the steps shown in FIG. 6A and allowed to swipe left to launch the replicated user interface of the Snapchat account of the user. Similarly, as in FIG. 6F, the users can go to the main page of the present integrated social media and instant messaging application and swipe left to view the replicated user interface of the twitter account of the user. In some instance, the integrated social media and instant messaging application allows the users to manually set the gestures to launch the replicated user interface of the respective application. The users can manually add additional online social media platforms and can be managed from the dynamic graphical user interface of the present integrated social media and instant messaging application.

Further, it should be noted that the steps described in the method of use can be carried out in many different orders according to user preference. The use of “step of” should not be interpreted as “step for”, in the claims herein and is not intended to invoke the provisions of 35 U.S.C. § 112, (6). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

We claim:

1. A system for connecting a plurality of users and to enable interaction between the users through an integrated online social media and instant messaging platform comprising:
a) an electronic communication device configured to run an integrated social media and instant messaging application,
b) wherein the integrated social media and instant messaging application includes:
a social networking module for providing a plurality of social media related services to the plurality of users;
a social media integration module for integrating a plurality of online social media platforms; and
an instant messaging module for enabling interaction between the plurality of users;
c) at least one server in communication with the electronic communication devices to manage a plurality of contents presented through the integrated social media and instant messaging application; and
d) a communication channel to enable communication between the electronic communication devices and the server;
e) whereby the integrated social media and instant messaging application allows the plurality of users to integrate the plurality of online social media platforms, enable interaction between the plurality of users and publish a plurality of contents through a dynamic graphical user interface of the integrated social media and instant messaging application.

2. The system of claim 1 wherein the electronic communication device includes:
a) a processor to process a plurality of instructions of the integrated social media and instant messaging application;
b) a storage unit to store the plurality of contents including text, audio, image and video;
c) a memory unit to temporarily store the plurality of contents during execution of the plurality of instructions by the processor;
d) a display unit to present the dynamic graphical user interface of the integrated social media and instant messaging application to the plurality of users;
e) a camera module to capture the plurality of contents including at least one image and video; and
f) at least one input-output means to provide the plurality of contents including text and audio.

3. The system of claim 1 wherein the electronic communication device is selected from a group consisting of a smartphone, tablet, computer, wearable smart devices and other smart devices capable of running the integrated social media and instant messaging application.

4. The system of claim 1 wherein the integrated social media and instant messaging application running on the electronic communication device allow the plurality of users to perform a plurality of tasks including:
integrate and interact with the plurality of online social media platforms through the dynamic graphical user interface of the integrated social media and instant messaging application;
capture the plurality of contents including image and video using the camera module and edit the contents using a plurality of options provided through the dynamic graphical user interface of the integrated social media and instant messaging application;
publish the plurality of contents including text, audio, image and video through selected online social media platforms and through the dynamic graphical user interface of the integrated social media and instant messaging application;
send the plurality of contents including text, audio, image and video in form of private messages to a plurality of users;
send a plurality of short-lived messages in form of text, audio, image and video to other users through the dynamic graphical user interface of the integrated social media and instant messaging application;
advertise through the dynamic graphical user interface of the integrated social media and instant messaging application; and
send invitations to the other users to join the integrated social media and instant messaging application and to view the plurality of contents presented through the dynamic graphical user interface.

5. The system of claim 1 wherein the integrated social media and instant messaging application enables the users to integrate the online social media platforms including Facebook, twitter, Google plus, Instagram, Snapchat, YouTube and other online content sharing, social networking and instant messaging applications.

6. The system of claim 1 wherein the integrated social media and instant messaging application allows the plurality of users to interact with the online social media platforms from within the dynamic graphical user interface of the integrated social media and instant messaging application.

7. The system of claim 6 wherein the dynamic graphical user interface of the integrated social media and instant messaging application provides replicated user interfaces for the online social media platforms including Facebook, twitter, Google plus, Instagram, Snapchat, YouTube and other online content sharing, social networking and instant messaging applications.

8. The system of claim 1 wherein the integrated social media and instant messaging application allows the plurality of users to respond to the plurality of contents published through the dynamic graphical user interface,
wherein a position of the contents published through the dynamic graphical user interface is dynamically updated based on a plurality of responses received from the users.

9. The system of claim 1 wherein the integrated social media and instant messaging application allows the plurality of users to launch the camera module of the electronic communication device to capture images and videos,
wherein the integrated social media and instant messaging application allows the users to store the images and videos in the storage unit,
wherein the integrated social media and instant messaging application allows the users to publish through the dynamic graphical user interface and/or the online social media platforms.

10. The system of claim 1 wherein the integrated social media and instant messaging application includes a voice to text translation engine to allow the users to record the short-lived messages in voice and send in form of text.

11. The system of claim 1 wherein the integrated social media and instant messaging application allows the users to set a desired time frame for the short-lived messages.

12. The system of claim 1 wherein the dynamic graphical user interface of the integrated social media and instant messaging application allows the users to edit the plurality of contents including videos captured using the camera module,
wherein the dynamic graphical user interface of the integrated social media and instant messaging application allows the users to add at least one geographical location in form of background of the video.

13. The system of claim 1 wherein the integrated social media and instant messaging application allows interaction between the plurality of users through real-time chats,
wherein the users can share text, audio, image and video through a chat window,
wherein the integrated social media and instant messaging application allows real-time modification of the audio, image and video shared through the chat window.

14. The system of claim 1 wherein the integrated social media and instant messaging application includes a livetime feature to allow the users to stream live images and video during real-time chats,
wherein the images and video shared using the livetime feature are made available to the plurality of users in form of public content.

15. The system of claim 1 wherein the integrated social media and instant messaging application allows the users to follow and/or subscribe to other users to receive the plurality of contents published by the other users through the dynamic graphical user interface,
wherein the plurality of contents published by the other users are presented through the dynamic graphical user interface in form of a story mode.

16. The system of claim 1 wherein the dynamic graphical user interface of the integrated social media and instant messaging application presents a ‘what's up feed’ feature to the users to publish a plurality of real-time events around the users,
wherein the users can publish the plurality of real-time events in form of text, audio, image and video.

17. A method for connecting a plurality of users and to enable interaction between the users through an integrated online social media and instant messaging platform comprising:
providing an electronic communication device installed with an integrated social media and instant messaging application;
allowing the plurality of users to register into the integrated social media and instant messaging application;
prompting each of the plurality of users to integrate a plurality of online social media platforms into the integrated social media and instant messaging application;
allowing the users to operate the online social media platforms from within a dynamic graphical user interface of the integrated social media and instant messaging application;
allowing the users to create, edit and share a plurality contents including text, audio, image and video through the dynamic graphical user interface;
enabling the users to follow and/or subscribe to a plurality of other users to receive the contents published by the other users;
allowing the users to react to the contents published by other users through the dynamic graphical user interface;
allowing the users to perform real-time chats through a chat window launched on the dynamic graphical user interface,
wherein the users can send a plurality of short-lived messages to a plurality of other users during the real-time chat;
wherein the users are allowed to perform public live streaming of images and videos through the dynamic graphical user interface during a livetime feature associated with the real-time chats; and
allowing the users to publish a plurality of real-time events occurring around the user,
wherein the users can publish the plurality of real-time events in form of text, audio, image and video.

18. The method of claim 17 wherein the plurality of users is allowed to share the plurality contents through a story mode presentation through the dynamic graphical user interface and through the online social media platforms integrated into the integrated social media and instant messaging application.

19. The method of claim 17 wherein the dynamic user interface of the integrated social media and instant messaging application presents a plurality of replicated user interfaces for the online social media platforms including Facebook, twitter, Google plus, Instagram, Snapchat, YouTube and other online content sharing, social networking and instant messaging applications,
wherein the users can launch the replicated user interfaces for the online social media platforms from within the dynamic graphical user interface of the integrated social media and instant messaging application using a plurality of gestures.

20. The method of claim 17 wherein the integrated social media and instant messaging application allows the users to send at least one text, audio, image and video in form of the short-lived messages.
